(19) United States
(12) Patent Application Publication
(10) Pub. No.: US 2018/0187711 A1
(43) Pub. Date: Jul. 5, 2018

(54) LOCKING NUT AND BOLT ASSEMBLIES FOR REDUCING WINDAGE IN THE VICINITY OF A HIGH PRESSURE FLOW REGION OF A GAS TURBINE ENGINE

(71) Applicant: General Electric Company, Schenectady, NY (US)

(72) Inventors: Narasimha KV Rao, Bangalore (IN); John Herbert Dimmick, III, Greenville, SC (US)

(73) Assignee: General Electric Company, Schenectady, NY (US)

(21) Appl. No.: 15/398,186

(22) Filed: Jan. 4, 2017

(51) Int. Cl. F16B 39/02; F16B 39/12

(52) U.S. Cl. CPC F16B 39/025; F16B 39/12

(57) ABSTRACT

A locking nut and bolt assembly for stacking rotating wheels is disclosed. The assembly may include a tie bolt extending through the stack of rotating wheels. The assembly also may include a locking nut positioned on an end of the tie bolt. The locking nut may include a closed cap.

### FIELD

The disclosure relates generally to gas turbine engines and more particularly relate to nut and bolt assemblies for reducing windage in the vicinity of a high pressure flow region (aft of a compressor) of a gas turbine engine.

### BACKGROUND

The rotors of rotary machines, such as turbines and compressors, generally include a number of axially stacked wheels. A number of circumferentially spaced blades are mounted in turn about the periphery of the wheels for rotation therewith. For example, compressor rotors generally include a series of individual compressor wheels stacked together with a set of tie bolts extending axially therethrough. The wheels mount the rotor blades thereon to form the compressor stages with a corresponding number of stator blades. The tie bolts typically are elongated studs that may be threaded at both ends. The tie bolts are enclosed by nuts to maintain the wheels in a stacked, assembled relationship relative to one another. A sufficient load is applied to the tie bolts to ensure that the rotor torque is carried through the stack by friction between the wheels.

### BRIEF DESCRIPTION

According to an embodiment, there is disclosed a locking nut and bolt assembly for stacking rotating wheels. The assembly may include a tie bolt extending through the stack of rotating wheels. The assembly also may include a locking nut positioned on a first end of the tie bolt. The locking nut may include a closed cap.

According to another embodiment, there is disclosed a system for reducing windage. The system may include a gas turbine engine having a compressor rotor, a bore through the compressor rotor, a counterbore disposed about the bore, a tie bolt disposed within the bore and the counterbore, a nut disposed within the counterbore about the tie bolt, and a locking nut disposed within the counterbore about a first end of the tie bolt. The locking nut may include a closed cap.

Further, according to another embodiment, there is disclosed a locking nut disposed within a counterbore about a first end of a tie bolt to reduce windage. The locking nut may include a closed cap, one or more staking notches disposed about a perimeter in the closed cap, and an aperture surrounding the tie bolt. The aperture may be closed off by the closed cap such that the aperture does not extend completely through the locking nut. In addition, the locking nut may include an aft face having two cutouts extend radially inward from a perimeter of the aft face.

Other embodiments, aspects, and features of the disclosure will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 depicts of an example gas turbine engine according to an embodiment.

FIG. 2 depicts a cross-sectional view of an example stacked wheel assembly for a rotary machine according to an embodiment.

FIG. 3 depicts a perspective view of a portion of the stacked wheel assembly for a rotary machine according to an embodiment.

FIG. 4 depicts a perspective view of a locking nut according to an embodiment.

FIG. 5 depicts a perspective view of a portion of the stacked wheel assembly for a rotary machine according to an embodiment.

FIG. 6 depicts a perspective view of a locking nut according to an embodiment.

FIG. 7 depicts a perspective view of a locking nut according to an embodiment.

FIG. 8 depicts a perspective view of a locking nut according to an embodiment.

### DETAILED DESCRIPTION

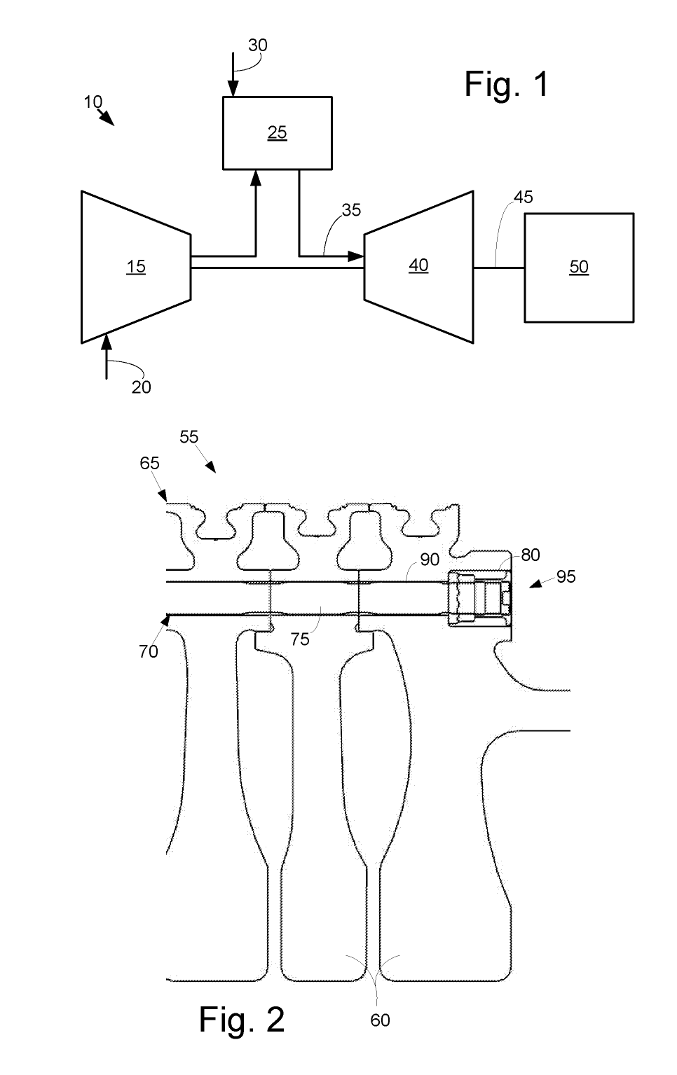

Referring now to the drawings, in which like numerals refer to like elements throughout the several views, FIG. 1 depicts a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

FIG. 2 depicts a portion of a rotary machine, in this case a compressor 55. The compressor 55 may be similar to the compressor 15 described above. As such, the compressor 55 includes a number of wheels 60. The wheels 60 may be arranged in a stack 65. The wheels 60 and the stack 65 may be maintained in an axial configuration by a number of tie bolt assemblies 70. The tie bolt assemblies 70 extend axially along the length of the compressor stack 65 or a number of tie bolt assemblies 70 may be used for a number of stages therein. Each tie bolt assembly 70 includes a tie bolt 75. The tie bolt 75 may be an elongated stud with an aft end 80 and a forward end (not shown). Each tie bolt 75 may have a number of bolt threads thereon. The bolt threads may extend along the length of the tie bolt 75 or just about the aft end 80 and/or the forward end. The tie bolt 75 extends through a bore 90 in each wheel 60 of the stack 65.

The aft end 80 of each tie bolt 75 may be secured via an aft nut assembly 95. In this example, aft nut assembly 95 may include a counterbore at an aft end of the bore 90 with a conventional twelve point nut therein that is secured in place by a locking nut. Other components and other configurations may be used herein.

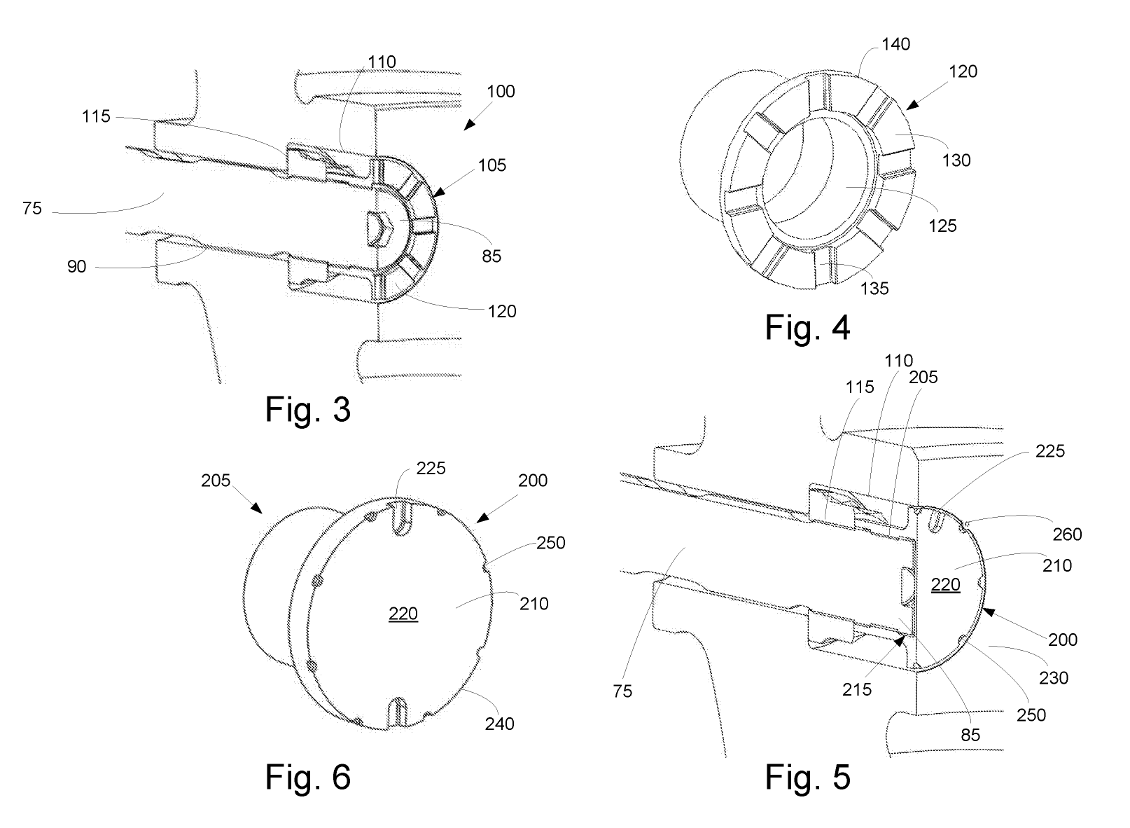

FIG. 3 depicts a typical aft nut assembly 100. The aft nut assembly 100 may be equally implemented as a forward nut assembly. In the aft nut assembly 100, the tie bolt 75 may be disposed within the bore 90. An aft end 105 of the bore 90 may include a counterbore 110. A nut 115, such as a conventional twelve point nut, may be disposed about the tie bolt 75 within the counterbore 110. The nut 115 may be secured within the counterbore 110 by a typical locking nut 120. As depicted in FIG. 4, the locking nut 120 may include an aperture 125. The aperture 125 may include internal threads configured to mate with the external threads on the tie bolt 75. That is, the tie bolt 75 may by threaded through the aperture 125 of the locking nut 120. In this manner, the aft end 85 of the tie bolt 75 may extend through the locking nut 120. The locking nut 120 may include an aft face 130. The aperture 125 may extend through the aft face 130. The aft face 130 may include a number of slots 135. The slots 135 may extend radially between a perimeter 140 of the aft face 130 and the aperture 125. The slots 135 may be used to tighten the locking nut 120. The configuration of the locking nut 120 may create a windage effect, which can increase local and downstream temperatures at critical locations in the gas turbine engine. In addition, windage may create undesirable pressure losses. In particular, the aperture 125 and the configuration of the slots 135 on the aft face 130 of the locking nut 120 may increase windage.

FIGS. 5 and 6 depict a locking nut 200 as may be described herein to reduce windage. That is, the locking nut 200 may eliminate or substantially reduce the above described windage effect. For example, the locking nut 200 may include an aperture 205. The aperture 205 may include internal threads configured to mate with the external threads on the aft end 85 of the tie bolt 75. That is, the tie bolt 75 may by threaded into the aperture 205 of the locking nut 200. In some instances, locking nut 200 may include different thread pitches in order to self-lock the locking nut. The locking nut 200, however, may include a closed cap 210, which may close off the aperture 205. In this manner, the aperture 205 may not extend completely through the locking nut 200. Instead, an aft end 215 of the aperture 205 may be closed off by the closed cap 210. As a result, the aft end 85 of the tie bolt 75 may not extend through the locking nut 120. Rather, the aft end 85 of the tie bolt 75 may be disposed within the aperture 205 and abut the inside of the closed cap 210.

The closed cap 210 may include an aft face 220. The aft face 220 may include a number of cutouts 225. Any number of cutouts 225 may be used. The cutouts 225 may be any size, shape, or configuration. The cutouts 225 may extend radially inward from a perimeter 230 of the aft face 220. In some instances, the cutouts 225 may not extend to the center of the aft face 220. The cutouts 225 may be used to tighten the locking nut 200. In a preferred embodiment, the cutouts 225 may be as small as possible while still enabling a tool to engage the cutouts 225 to tighten the locking nut 200. In some instances, the locking nut 200 may include no more than two cutouts 225 diametrically opposed to each other. In other instances, the locking nut 200 may include more than two cutouts 225.

In certain embodiments, the aft face 220 may be parallel to and flush with a surface 230 of the wheel 60. That is, the aft face 220 and the surface 230 of the wheel 60 may be in the same plane. In this manner, the locking nut 200 may be inserted onto the tie bolt 75 and into the counterbore 110 until the aft face 220 is flush with the surface 230 of the wheel 60. The aft face 220 may include a perimeter 240 about the circumference of the aft face 220. The perimeter 240 may include one or more staking notches 250. In some instances, the staking notches 250 may be disposed in a circumferential array. Any number of staking notches 250 may be used. The staking notches 250 may be any size, shape, or configuration. In one embodiment, the stacking notches 250 may be half circles. In this manner, the surface 230 of the wheel 60 about the counterbore 110 may be staked 260 in order to maintain the locking nut 200 in place. That is, staking the locking nut 200 may prevent rotation of the locking nut 200. The closed cap and the omission of the slots may eliminate or substantially reduce the windage effect.

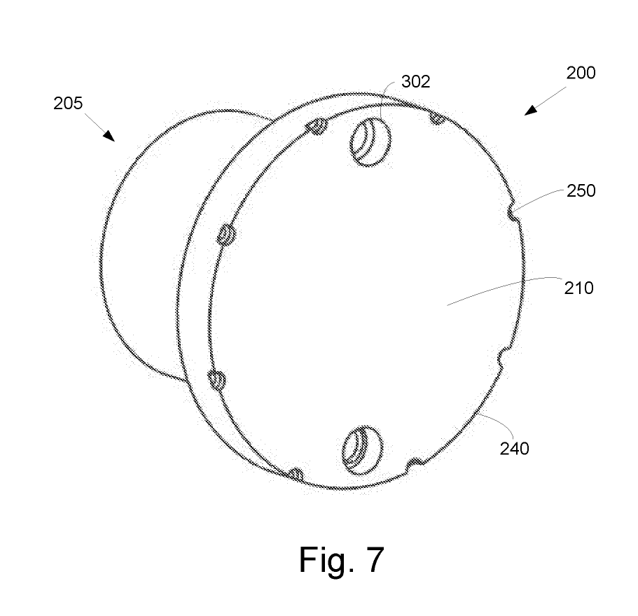

FIG. 7 depicts locking nut 300 as may be described herein to reduce windage. The locking nut 300 is similar to the locking nut 200 except for the configuration of the cutouts 225. That is, the locking nut 300 includes circular cutouts 302. Any number of cutouts 302 may be used. The cutouts 302 may be any size, shape, or configuration. The cutouts 302 may be disposed radially inward from a perimeter 230 of the aft face 220. The cutouts 302 may be used to tighten the locking nut 200. In a preferred embodiment, the cutouts 302 may be as small as possible while still enabling a tool to engage the cutouts 302 to tighten the locking nut 300. In some instances, the locking nut 300 may include no more than two circular cutouts 302 diametrically opposed to each other. In other instances, the locking nut 300 may include more than two circular cutouts 302. The cutouts 225, 302 may be any size, shape, or configuration. In some instances, the cutouts 225, 302 may be omitted.

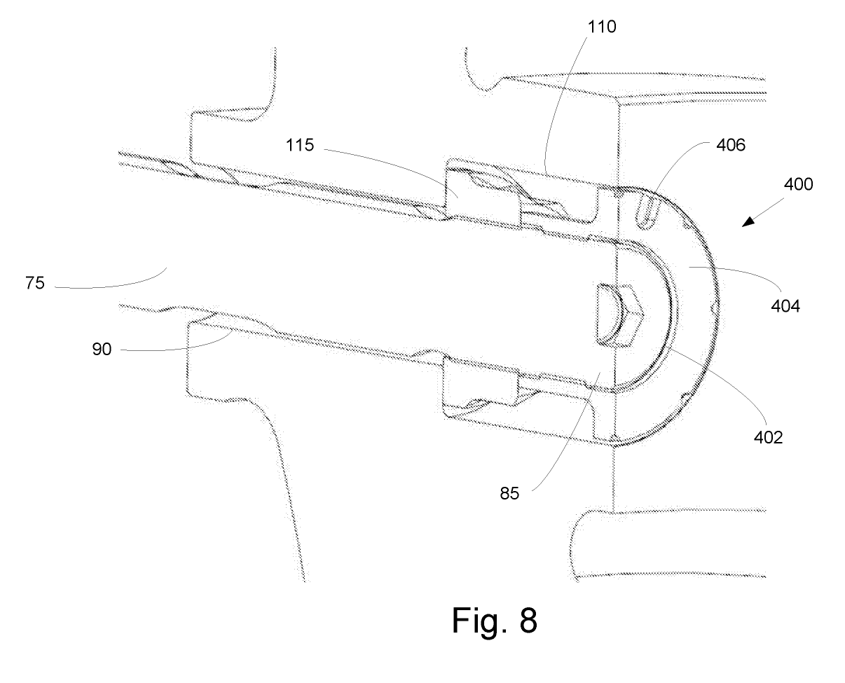

FIG. 8 depicts locking nut 400 as may be described herein to reduce windage. The locking nut 400 may include an aperture 402. The aperture 402 may include internal threads configured to mate with the external threads on the tie bolt 75. That is, the tie bolt 75 may by threaded through the aperture 402 of the locking nut 400. In this manner, the aft end 85 of the tie bolt 75 may extend through the locking nut 400. The locking nut 400 may include an aft face 404. The aperture 402 may extend through the aft face 404. The aft face 404 may include a number of slots 406. The slots 406 may extend radially between a perimeter 408 of the aft face 404 to just before the aperture 402. The slots 406 may be any size, shape, or configuration. The slots 406 may be used to tighten the locking nut 400. The locking nut 400 may include staking notches as described above.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof. Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A locking nut and bolt assembly for stacking rotating wheels, the assembly comprising:
a tie bolt extending through the stack of rotating wheels; and
a locking nut positioned on an end of the tie bolt, wherein the locking nut comprises a closed cap.

2. The assembly of claim 1, wherein the closed cap comprises one or more staking notches.

3. The assembly of claim 2, wherein the one or more staking notches are disposed about a perimeter of the closed cap.

4. The assembly of claim 1, wherein the closed cap is flush with a surface of one of the rotating wheels.

5. The assembly of claim 1, wherein the locking nut comprises an aperture surrounding the tie bolt.

6. The assembly of claim 5, wherein the aperture is closed off by the closed cap such that the aperture does not extend completely through the locking nut.

7. The assembly of claim 6, wherein the end of the tie bolt is disposed within the aperture and abuts an inner surface of the closed cap.

8. The assembly of claim 1, wherein the closed cap comprises an aft face.

9. The assembly of claim 8, wherein the aft face comprises a plurality of cutouts.

10. The assembly of claim 9, wherein the plurality of cutouts extend radially inward from a perimeter of the aft face.

11. A system, comprising:
a gas turbine engine having a compressor rotor;
a bore through the compressor rotor;
a counterbore disposed about the bore;
a tie bolt disposed within the bore and the counterbore;
a nut disposed within the counterbore about the tie bolt; and
a locking nut disposed within the counterbore about an end of the tie bolt, wherein the locking nut comprises a closed cap.

12. The system of claim 11, wherein the closed cap comprises one or more staking notches.

13. The system of claim 12, wherein the one or more staking notches are disposed about a perimeter of the closed cap.

14. The system of claim 11, wherein the closed cap is flush with a surface of one of the compressor rotor.

15. The system of claim 11, wherein the locking nut comprises an aperture surrounding the tie bolt.

16. The system of claim 15, wherein the aperture is closed off by the closed cap such that the aperture does not extend completely through the locking nut.

17. The system of claim 16, wherein the end of the tie bolt is disposed within the aperture and abuts an inner surface of the closed cap.

18. The system of claim 1, wherein the closed cap comprises an aft face having a plurality of cutouts.

19. The system of claim 18, wherein the plurality of cutouts extend radially inward from a perimeter of the aft face.

20. A locking nut disposed within a counterbore about an end of a tie bolt to reduce windage, the locking nut comprising:
a closed cap;
one or more staking notches disposed about a perimeter in the closed cap;
an aperture surrounding the tie bolt, wherein the aperture is closed off by the closed cap such that the aperture does not extend completely through the locking nut; and
an aft face having two cutouts extend radially inward from a perimeter of the aft face.
